(19) United States
(12) Patent Application Publication
(10) Pub. No.: US 2008/0151546 A1
(43) Pub. Date: Jun. 26, 2008

(54) 3D ornamental light

(76) Inventor: George Tsai, Taipei (TW)

Correspondence Address: COOPER & DUNHAM, LLP, 1185 AVENUE OF THE AMERICAS, NEW YORK, NY, 10036, US

(21) Appl. No.: 11/643,233

(22) Filed: Dec. 20, 2006

(51) Int. Cl. F21S 13/14

(52) U.S. Cl. 362/252

(57) ABSTRACT

A three-dimensional (3D) ornamental light has an axis, multiple loop casings and multiple pairs of connectors. The loop casings are pervious to light and are mounted rotatably on each other in a concentric arrangement. Each loop casing has an outer edge, a cavity, multiple relief bumps and multiple lighting elements. The relief bumps are formed irregularly on the outer surface of the loop casing. The lighting elements are mounted in the cavity. Each pair of the connectors is mounted on two adjacent loop casings, rotatably connects the adjacent loop casings together. The connectors of each pair are located respectively at the tip ends of each of the adjacent loop casings. With the connectors, the loop casings may rotate to locate respectively at different angular positions according to the axis to perform various visual effects.

### BACKGROUND OF THE INVENTION

1. Field of the Invention

The present invention relates to a light, and more particularly to a three-dimensional ornamental light that has a changeable configuration to display various visual effects.

2. Description of Related Art

Lights have been used throughout human life. Additionally, both houses and commercial building have been fully wired so that electrical aesthetic lights may be utilized for ornamental purposes in most all buildings. Ornamental lights have a feature over all other ornamental articles because their visual effects may change dramatically from daylight to nighttime.

However, conventional ornamental lights have an unchangeable configuration that greatly limits the visual effects.

To overcome the shortcomings, the present invention provides a three-dimensional ornamental light to mitigate or obviate the aforementioned problems.

### SUMMARY OF THE INVENTION

The main objective of the invention is to provide a three-dimensional (3D) ornamental light that has a changeable configuration to display various visual effects.

A three-dimensional (3D) ornamental light in accordance with the present invention comprises an axis, multiple loop casings and multiple pairs of connectors.

The loop casings are pervious to light and are mounted rotatably on each other in a concentric arrangement. Each loop casing has an outer edge, a cavity, multiple relief bumps and multiple lighting elements. The relief bumps are formed irregularly on the outer surface of the loop casing. The lighting elements are mounted in the cavity.

Each pair of the connectors is mounted on two adjacent loop casings, rotatably connects the adjacent loop casings together. The connectors of each pair are located respectively at the tip ends of each of the adjacent loop casings.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a three-dimensional (3D) ornamental light in accordance with the present invention;

FIG. 2 is an operational perspective view of the 3D ornamental light in FIG. 1 with the loop casings arranged respectively at different angular positions according to the axis;

FIG. 3 is a front view of the 3D ornamental light in FIG. 1 with one casing half of each loop casing detached, one pin half of each pin detached and one bushing half of each bushing detached;

FIG. 4 is an enlarged front view of the 3D ornamental light in FIG. 3;

FIG. 5 is an enlarged and exploded perspective view of the 3D ornamental light in FIG. 1;

FIG. 6 is an exploded perspective view of the pin and the bushing of the connector of the 3D ornamental light in FIG. 5; and

FIG. 7 is a cross sectional end view of the 3D ornamental light along line 7-7 in FIG. 4.

### DETAILED DESCRIPTION OF THE PREFERRED EMBODIMENT

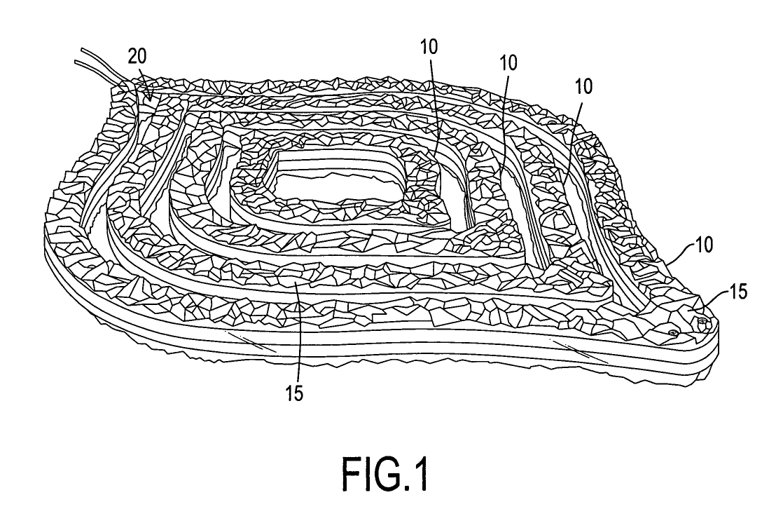

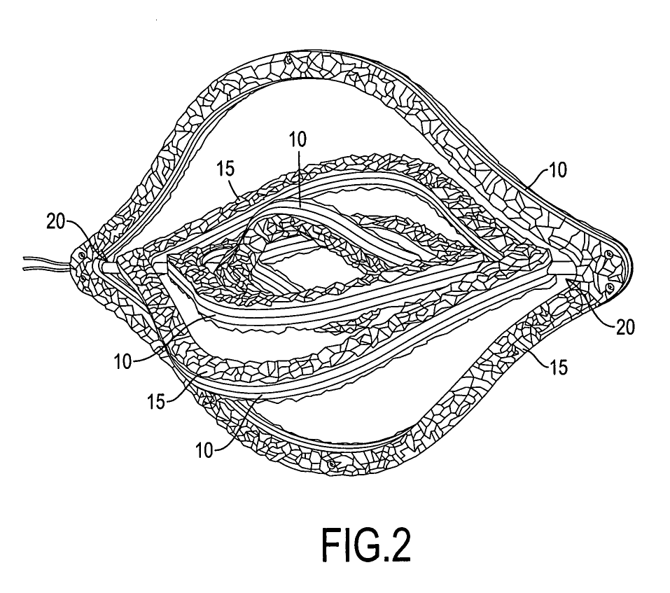

With reference to FIGS. 1 and 2, a three-dimensional (3D) ornamental light in accordance with the present invention has different configurations to display various visual effects.

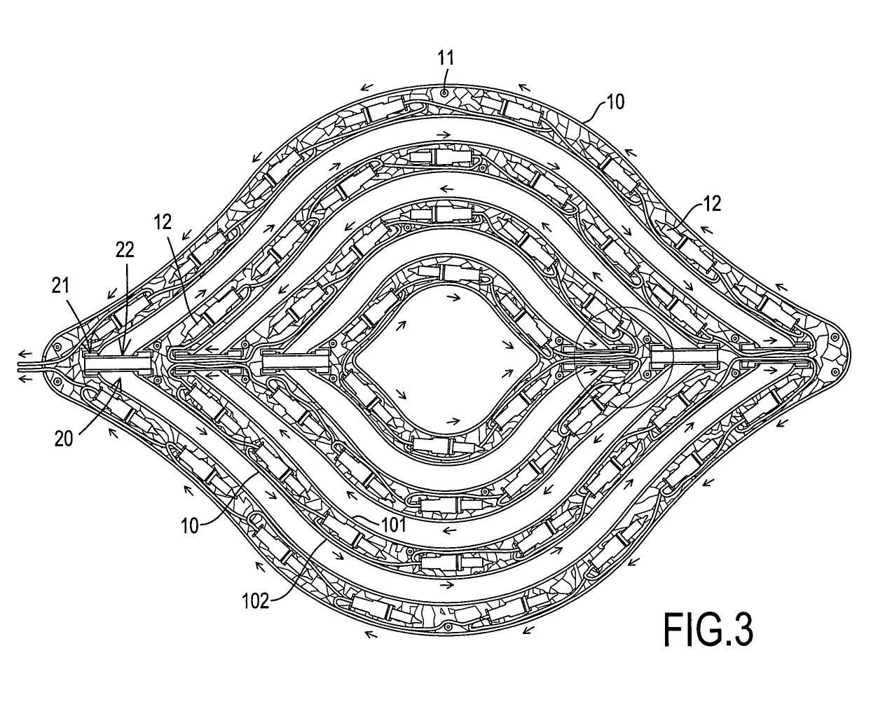

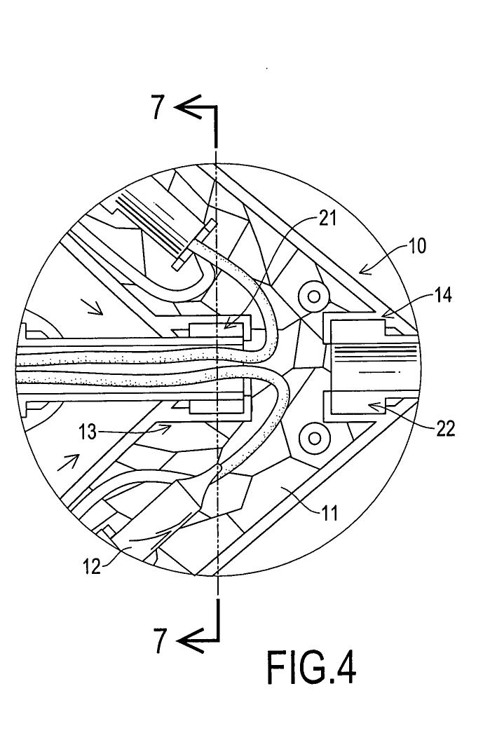

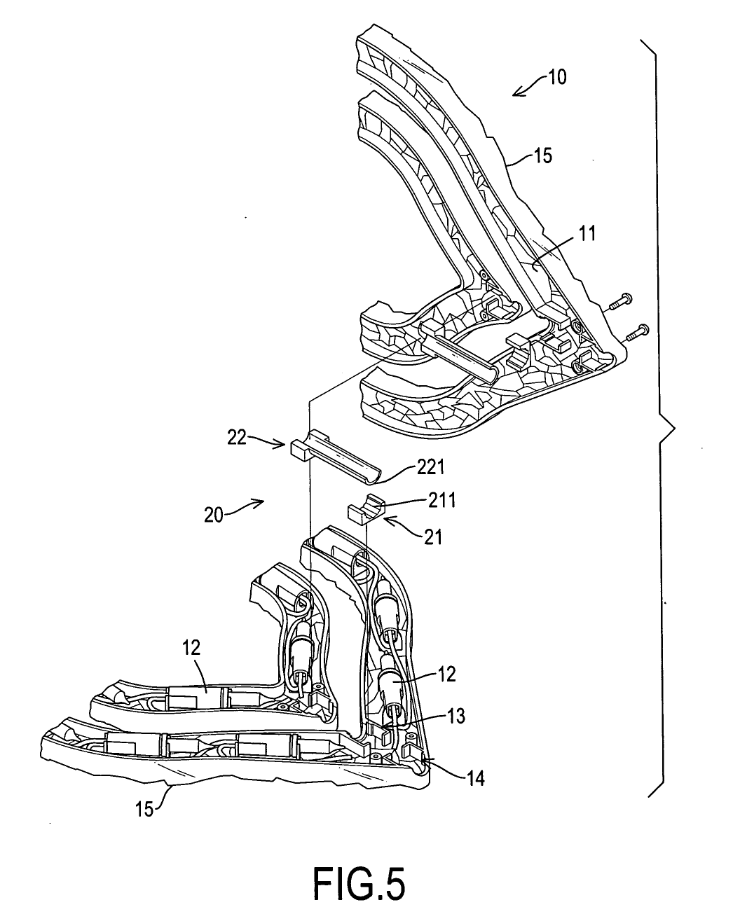

With further reference to FIGS. 3, 4 and 5, the 3D ornamental light comprises an axis, multiple loop casings (10), multiple pairs of retainer assemblies and multiple pairs of connectors (20).

The loop casings (10) are olive-shaped, are pervious to light, may be transparent or translucent and are mounted rotatably on each other in a concentric arrangement. Each loop casing (10) is capable of rotating on the axis, comprises a front casing half and a rear casing half and has an outer surface, an inner edge (101), an outer edge (102), two tip ends, an outer surface, a cavity (11), multiple relief bumps (15) and multiple lighting elements (12).

The front and rear casing halves are mounted on each other to form the loop casing (10).

The tip ends are located along the axis of the 3D ornamental light.

The cavity (11) is defined in the loop casing (10) and has an inner surface.

The relief bumps (15) are formed irregularly on the outer surface of the loop casing (10) and diffuse light passing through and extending out of the loop casing (10) to cause various light effects.

The lighting elements (12) may be bulbs or light emitting diodes, are mounted in the cavity (11) in the loop casing (10), are connected together and are capable of radiating light through the loop casing (10).

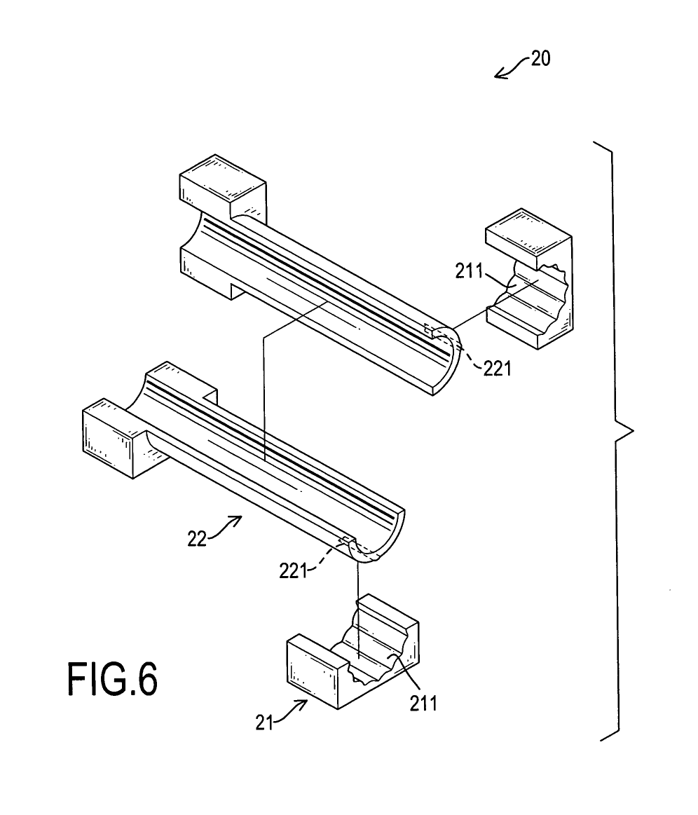

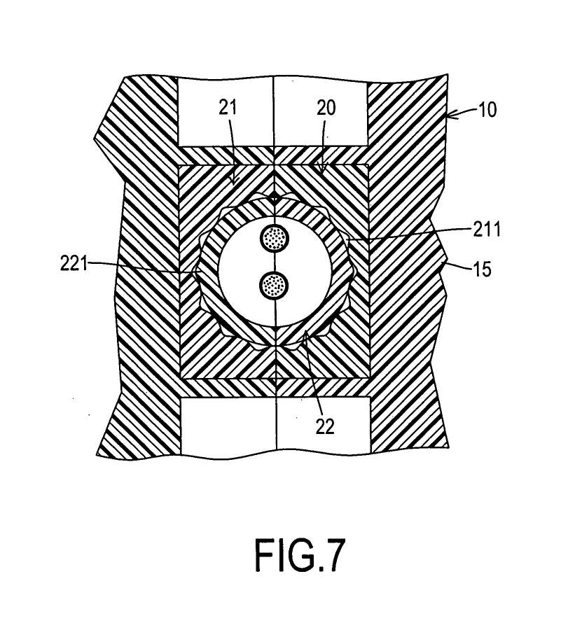

With further reference to FIGS. 6 and 7, each pair of the retainer assemblies is attached to two adjacent loop casings (10) and each retainer assembly has a bushing retainer (13) and a pin retainer (14).

The bushing retainer (13) is formed on the inner surface of the cavity (11) of an outer one of the adjacent loop casings (10) and is located adjacent to the inner edge (101) at one tip end of the outer one of the adjacent loop casings (10).

The pin retainer (14) is formed on the inner surface of the cavity (11) of an inner one of the adjacent loop casings (10) and is located adjacent to the outer edge (102) at one tip end of the inner one of the adjacent loop casings (10).

An outermost one of the loop casings (10) only has the bushing retainer (13) but does not have the pin retainer (14). An innermost one of the loop casings (10) only has the pin retainer (14) but does not have the bushing retainer (13). Intervening loop casings (10) between the outermost and innermost loop casings (10) has both the bushing retainer (13) and the pin retainer (14), as shown in FIG. 3.

The pairs of the connectors (20) correspond respectively to the pairs of the retainer assemblies. Each pair of the connectors (20) is mounted on two adjacent loop casings (10), rotatably connects the adjacent loop casings (10) together. The connectors (20) of each pair are located respectively at the tip ends of each of the adjacent loop casings (10) and each connector (20) has a bushing (21) and a pivot pin (22).

The bushing (21) is mounted in the cavity (11) in an outer one of the adjacent loop casings (10), is held by the bushing retainer (13) on the outer one of the adjacent loop casings (10), comprises two bushing halves and has a mounting hole and multiple keyways (211). The bushing halves are mounted on each other to form the bushing (21). The mounting hole is defined through the bushing (21) along the axis and has an inner surface. The keyways (211) are defined radially in the inner surface of the mounting hole.

The pivot pin (22) is mounted in the cavity (11) in an inner one of the adjacent loop casings (10), extends rotatably in the mounting hole in the bushing (21), comprises two pin halves and has an outer surface and at least one key (221). The pin halves are mounted on each other to form the pivot pin (22). The at least one key (221) is formed on and extends radially out from the outer surface of the pivot pin (22) and selectively engage respectively with at least one of the keyways (211) in the mounting hole in the bushing (21) to hold the pivot pin (22) at a specific angular position on the bushing (10). With the engagement of the at least one key (221) and at least one keyways (211), the adjacent loop casings (10) may be positioned in any angular positions according to the axis as people's desire.

With reference to FIG. 2, the loop casings (10) may rotate to locate respectively at different angular positions according to the axis of the 3D ornamental light so a configuration of the 3D ornamental light varies. Therefore, the 3D ornamental light with the variable configuration displays various visual effects. Furthermore, the relief bumps (15) on the loop casings (10) diffusing lights from the lighting elements (12) make the 3D ornamental light glaring and attractive.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A three-dimensional (3D) ornamental light comprising:
an axis;
multiple loop casings being pervious to light and mounted rotatably on each other in a concentric arrangement, and each loop casing capable of rotating on the axis and having
two tip ends located along the axis;
an outer surface;
an inner edge;
an outer edge;
a cavity defined in the loop casing and having an inner surface;
multiple relief bumps formed irregularly on the outer surface of the loop casing; and
multiple lighting elements mounted in the cavity in the loop casing, connected together and capable of radiating light through the loop casing; and
multiple pairs of connectors, each pair of the connectors mounted on two adjacent loop casings, rotatably connecting the adjacent loop casings together and the connectors of each pair located respectively at the tip ends of each of the adjacent loop casings.

2. The 3D ornamental light as claimed in claim 1, wherein each connector of each pair has
a bushing mounted in the cavity in an outer one of the adjacent loop casings and having
a mounting hole defined through the bushing along the axis and having an inner surface; and
multiple keyways defined radially in the inner surface of the mounting hole; and
a pivot pin mounted in the cavity in an inner one of the adjacent loop casings, extending rotatably in the mounting hole in the bushing and having
an outer surface; and
at least one key formed on and extending radially out from the outer surface of the pivot pin and selectively engaging respectively with at least one of the keyways in the mounting hole in the bushing to hold the pivot pin at a specific angular position on the bushing.

3. The 3D ornamental light as claimed in claim 2 further comprising multiple pairs of the retainer assemblies corresponding respectively to the pairs of the connectors, wherein each pair of the retainer assemblies is attached to two adjacent loop casings and each retainer assembly of each pair has
a bushing retainer formed on the inner surface of the cavity of an outer one of the adjacent loop casings, located adjacent to the inner edge at the one tip end of the outer one of the adjacent loop casings and holding the bushing of one connector of a corresponding pair; and
a pin retainer formed on the inner surface of the cavity of an inner one of the adjacent loop casings, located adjacent to the outer edge at one tip end of the inner one of the adjacent loop casings and holding the pivot pin of one connector of a corresponding pair.

4. The 3D ornamental light as claimed in claim 3, wherein each loop casing is transparent.

5. The 3D ornamental light as claimed in claim 3, wherein each loop casing is translucent.
